(19) United States
(12) Patent Application Publication
(10) Pub. No.: US 2024/0151910 A1
(43) Pub. Date: May 9, 2024

(54) BULKHEAD ADAPTER ASSEMBLY HAVING INTEGRALLY MOLDED BODY AND METHOD OF FORMING SAME

(71) Applicant: Steven E. Kaplan, Elyria, OH (US)

(72) Inventor: Steven E. Kaplan, Elyria, OH (US)

(21) Appl. No.: 18/387,166

(22) Filed: Nov. 6, 2023

Related U.S. Application Data
(60) Provisional application No. 63/423,121, filed on Nov. 7, 2022.

(51) Int. Cl. G02B 6/38

(52) U.S. Cl. CPC G02B 6/3825

(57) ABSTRACT

A bulkhead adapter assembly, and method of forming same, is configured at a first end to receive an associated optical fiber connector housing a terminal end of an associated fiber. The adapter assembly is joined to an associated closure at a second end. The bulkhead adapter assembly includes a holder having first and second flexible arms extending axially outwardly from a first end of the holder along a first axis. The first end of the holder includes an opening dimensioned to receive the associated optical fiber therein. A shoulder is formed at a terminal end of each of the flexible arms wherein each shoulder has an undercut extending perpendicularly to the first axis that is configured to operatively engage the associated optical fiber connector. A central portion of the holder has a recess extending inwardly from a second end of the holder, with an opening that receives the associated optical fiber therethrough. A sleeve is dimensioned for axial receipt in the holder recess dimensioned to receive the associated optical fiber therein, the sleeve aligning the associated optical fiber within the bulkhead adapter assembly. A hollow body has a recess that receives the holder and sleeve in a first end of the body, the body including an externally threaded first region and an internally threaded second region. A nut has an internally threaded region that engages the externally threaded first region of the hollow body and having an internal shoulder. A base member has an externally threaded region that threadedly interconnects with the internally threaded second region of the body.

### BACKGROUND

This application claims the priority benefit of U.S. provisional application Ser. No. 63/423,121, filed Nov. 7, 2022, the entire disclosure of which is expressly incorporated herein by reference.

This disclosure relates to an adapter assembly, and particularly a modified adapter (also referred to as a bulkhead adapter assembly or bulkhead adapter) that connects outside and internal cables. This bulkhead adapter disclosure finds particular application in connecting optical fibers that are received in opposite ends of the adapter without a significant loss in transmission that are typically used in the telecommunications industry.

It is known to provide a housing or enclosure where multiple optical fibers from a fiber optic cable are segregated from one another, and also segregated from a remainder of the cable assembly. The segregated fibers are used to connect with a drop cable in the fiber optic network industry. Preferably, the drop cable has a pre-connectorized end that is configured for a snap-fit, plug-in connection with one end of the bulkhead adapter assembly, and more particularly with the body of the bulkhead adapter assembly. An opposite face or end of the body of the bulkhead adapter assembly is similarly configured to receive an end of a connector provided on the end of the segregated optical fiber located in the enclosure housing. In this manner, the individual components properly interconnect with one another.

Bulkhead adapter assembly's that achieve these general objectives are known in the industry. Is, however, desire to reduce the number of components or individual components used in the bulkhead adapter assembly in order to reduce cost. Further, a smaller number of components leads to reduced inventory, simpler assembly, and reduces tolerance stack-up issues. A reduced number of components also, in turn, reduces the number of potential leak paths in the assembly.

Consequently, a need exists for an improved arrangement that addresses one or more of the issues noted above, and provides at least one or more of the above-described features, as well as still other features and benefits when compared to other, known bulkhead adapter assemblies.

### SUMMARY

A new and improved bulkhead adapter assembly is provided.

The bulkhead adapter assembly (and method of forming same) is configured at a first end to receive an associated optical fiber connector housing a terminal end of an associated fiber. The adapter assembly is joined to an associated closure at a second end. The bulkhead adapter assembly includes a holder having first and second flexible arms extending axially outwardly from a first end of the holder along a first axis. The first end of the holder includes an opening dimensioned to receive the associated optical fiber therein. A shoulder is formed at a terminal end of each of the flexible arms wherein each shoulder has an undercut extending perpendicularly to the first axis that is configured to operatively engage the associated optical fiber connector. A central portion of the holder has a recess extending inwardly from a second end of the holder, with an opening that receives the associated optical fiber therethrough. A sleeve is dimensioned for axial receipt in the holder recess dimensioned to receive the associated optical fiber therein, the sleeve aligning the associated optical fiber within the bulkhead adapter assembly. A hollow body has a recess that receives the holder and sleeve in a first end of the body, the body including an externally threaded first region and an internally threaded second region. A nut has an internally threaded region that engages the externally threaded first region of the hollow body and having an internal shoulder. A base member has an externally threaded region that threadedly interconnects with the internally threaded second region of the body.

The sleeve in one variation may be a ceramic material.

The adapter assembly may include a first seal member interposed between the nut and body, and a second seal member interposed between the body and base member to seal around the associated optical fiber connector.

Each of the flexible arms may include a tapered surface adjacent a terminal end thereof configured to abuttingly engage the associated optical fiber connector such that the arms diverge away from each other as the associated optical fiber connector is advanced relative to the flexible arms.

Each of the flexible arms may include a tapered surface adjacent a terminal end thereof configured to abuttingly engage the associated optical fiber connector such that the arms diverge away from each other as the associated optical fiber connector is advanced relative to the flexible arms.

The central portion of the holder may be located axially inward from terminal ends of the first and second flexible arms such that the flexible arms extend over a greater axial extent of the associated optical fiber connector when received in the holder recess.

The nut includes one or more indentations/notches configured to receive a mating, specially configured associated tool to rotate the nut onto the body and retain the holder and sleeve in the body.

A method of assembling a bulkhead adapter assembly configured at a first end to receive an associated optical fiber connector housing a terminal end of an associated fiber, and joined to an associated closure at a second end, includes providing an elongated holder having at least first and second flexible arms extending axially outwardly from a first end of the holder along a first axis. Providing the first end of the holder may include providing an opening dimensioned to receive the associated optical fiber therein, a shoulder formed at a terminal end of each of the flexible ends wherein each shoulder has an undercut extending perpendicularly to the first axis that is configured to operatively engage the associated optical fiber connector, a central portion of the holder including a recess extending inwardly from a second end of the holder, and an opening through the central portion that receives the associated optical fiber therethrough.

The method may include receiving a sleeve in the holder recess dimensioned wherein the sleeve is dimensioned to receive the associated optical fiber therein.

The method may include using the sleeve to align the associated optical fiber within the bulkhead adapter assembly.

The method may include providing a hollow body having a recess and receiving the holder and sleeve in a first end of the body, the body including an externally threaded first region and an internally threaded second region.

The method may include threadedly engaging a nut having an internally threaded region with the externally threaded first region of the hollow body, and threadedly engaging a base member having an externally threaded region with the internally threaded second region of the body.

The method may include forming the sleeve of a ceramic material.

The method may include interposing a first seal member between the nut and body, and interposing a second seal interposed between the body and base member to seal around the associated optical fiber connector.

The method may include providing a tapered surface adjacent a terminal end of each flexible arm to abuttingly engage the associated optical fiber connector such that the arms diverge away from each other as the associated optical fiber connector is advanced relative to the flexible arms.

The method may include locating the central portion of the holder axially inward from terminal ends of the first and second flexible arms such that the flexible arms extend over a greater axial extent of the associated optical fiber connector when received in the holder recess. The method of claim 8 further comprising providing one or more indentations/notches in the nut configured to receive a mating, specially configured associated tool to rotate the nut onto the body and retain the holder and sleeve in the body.

The new assembly reduces the number of components or individual components used in the bulkhead adapter assembly, thereby reducing costs.

A smaller number of components results in reduced inventory issues.

Further, the overall assembly is easy to assemble.

Tolerance stack-up issues are addressed since a lesser number of components are used and thus the overall number of tolerances between assembled components is reduced.

There are also fewer potential leak paths in the assembly as a result of using fewer components.

Still other benefits and advantages of the present disclosure will become more apparent from reading and understanding the following detailed description.

### BRIEF DESCRIPTION OF THE DRAWINGS

FIG. 1 is an exploded, perspective view of a preferred bulkhead adapter assembly that particularly illustrates the individual components prior to assembly.

FIG. 2 is an enlarged elevational view of a holder component of the bulkhead adapter assembly of FIG. 1.

FIG. 3 is an enlarged, longitudinal cross-sectional view of the holder of FIG. 2.

FIG. 4 is an enlarged end view of an internally threaded nut component of the bulkhead adapter assembly of FIG. 1.

FIG. 5 is an enlarged, longitudinal view of a body of the bulkhead adapter assembly of FIG. 1 with selected portions thereof shown in elevation.

FIG. 6 is an enlarged, longitudinal cross-sectional view of a dust cap received over a first end of the bulkhead adapter assembly of FIG. 1.

FIG. 7 is an enlarged, longitudinal cross-sectional view of a dust cap received at a second end of the bulkhead adapter assembly of FIG. 1.

FIG. 8 includes FIG. 8A which is an exploded, perspective view of a prior art bulkhead adapter assembly that particularly illustrates the individual components thereof prior to assembly, and FIG. 8B which is an enlarged, exploded view of the shroud subassembly of FIG. 8A.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise. Use of dimensions, temperatures, ranges, time, relationships (e.g., “perpendicular”, “parallel”), etc. that either use or do not use further adjectives such as “generally”, “substantially”, “about” or “approximately” in the description or claims are intended to cover both the specific dimension, temperature, range, time, relationship, etc., as well as a range of equivalents (function, way, or result) and only intended to be limited by teachings of the prior art.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

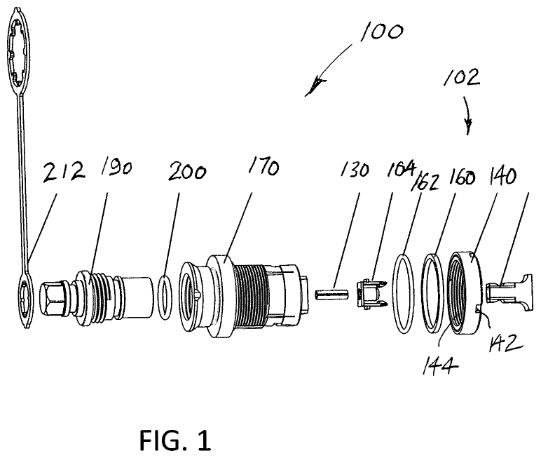

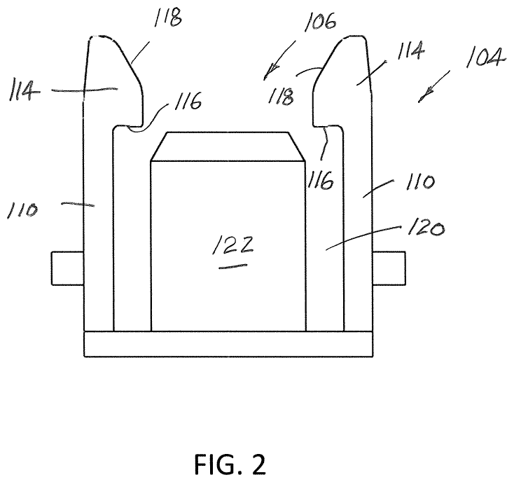

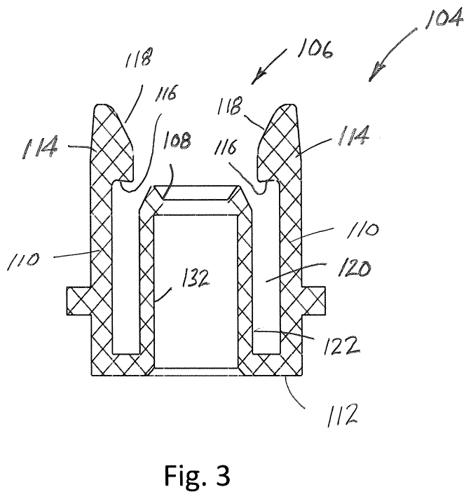

Turning to FIG. 1, and also FIGS. 2-7, there is shown a bulkhead adapter or bulkhead adapter assembly 100. The adapter 100 receives one end of a first fiber optic cable (not shown), and particularly an exposed optical fiber thereof, that leads from, for example, an enclosure or housing (not shown). The fiber optic cable includes a connector (not shown) configured for receipt in a first or right-hand end 102 of the adapter 100 as oriented in FIG. 1. The fiber optic cable connector is dimensioned for receipt in the adapter 100 where the exposed optical fiber is inserted into a holder 104. A first end 106 of the holder 104 includes an opening 108 (FIG. 3) dimensioned to receive the optical fiber therein. The holder 104 also preferably includes two or more flexible arms 110 that have an elongated conformation and extend axially in cantilevered fashion from second end 112 of the holder. Each arm 110 preferably includes a shoulder 114 at the first end 106 with an undercut 116 extending substantially perpendicular to longitudinal direction of the arm for snap-fit connection. That is, the optical fiber connector (not shown) is advanced toward the holder 104, the tapered surface 118 abuttingly engages the optical fiber connector, the arms 110 diverge outwardly (substantially perpendicular to the longitudinal axis of the holder) as the tapered surfaces ride over the optical fiber connector to receive at least a portion of the connector in a cavity 120 between a central portion 122 of the holder and the arms, and then the undercuts 116 move inwardly (i.e., snap-fit) and secure the optical fiber connector to the holder. The optical fiber is received through the opening 108 for receipt in one end of a ceramic sleeve 130 (FIG. 1). The ceramic sleeve 130 serves to align the end of the optical fiber from the housing/enclosure (from the right-hand end of FIG. 1) with a similar optical fiber extending from a drop cable (extending from the left-hand end of FIG. 1—not shown). The ceramic sleeve 130 is dimensioned for receipt in recess 132 of the holder 104, where the recess extends axially inward from the second end 112 and is in communication with the opening 108 adjacent the first end 106 of the holder.

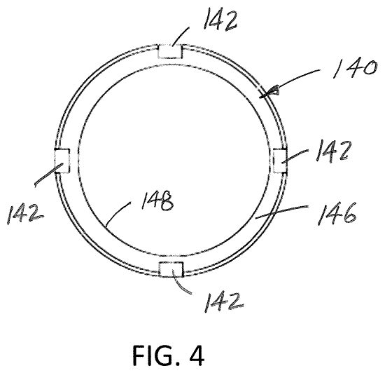

With continued reference to FIG. 1, and additional reference to FIG. 4, an internally threaded member or jam nut 140 is shown. A first or outer end of the nut 140 includes one or more indentations or notches 142 that are dimensioned to receive a specially configured tool (not shown) having a like number of circumferentially spaced tabs. The tabs of the tool engage the notches 142 and facilitate tightening and/or loosening the nut 140. The nut 140 is internally threaded 144 (FIG. 1) and also includes a circumferentially continuous shoulder 146 (FIG. 4) that extends radially inward toward a central axis of the through opening 148 through the nut. The shoulder 146 serves to axially capture or contain a ring 160 and a separate seal member (first seal member, seal ring or o-ring) 162.

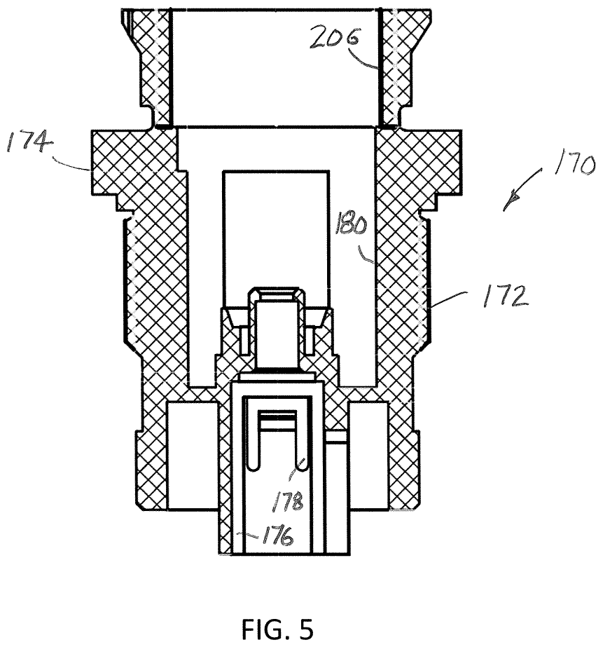

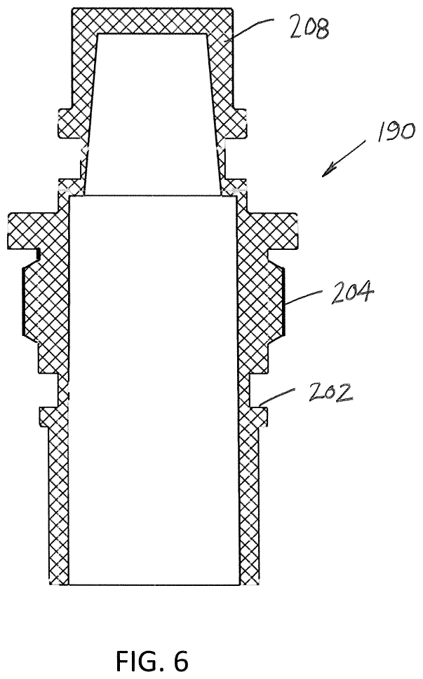

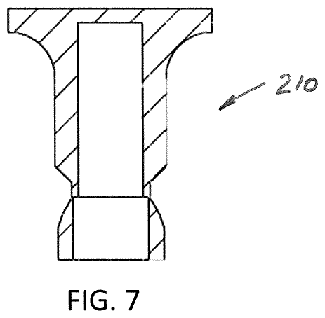

The bulkhead adapter 100 also includes a hollow body 170 (FIGS. 1 and 5) that receives components and/or interacts with other components of the assembly at opposite ends thereof. For example, an externally threaded portion 172 threadedly receives the internal threads 144 of the nut 140. As the nut 140 is rotated into tightening engagement with the body 170, the shoulder 146 of the nut and ring 160 urges the seal member 162 against an externally raised shoulder 174. This assures that the optical fiber and connector received in the holder 104 and ceramic sleeve 130 from the housing/enclosure is sealed from the external environment. As perhaps best illustrated in FIG. 5, the holder 104 is received in a similarly configured internal first recess 176. Axial legs 178 are received between the arms 110 of the holder 104 for alignment of the holder in the body 170. Similarly, a second recess 180 is formed at the other end of the body 170 to receive a closure member (described further below). The recesses number 176, 180 prevent relative rotation between the body and the holder, and between the body and a closure member 190 (FIG. 6), respectively. A second seal member (seal ring or o-ring) 200 (FIG. 1) is dimensioned for receipt in an external groove 202 of the closure member 190 (FIG. 6). Further, the closure member 190 is externally threaded along portion 204 (FIG. 6) for operative, threaded engagement with internal threads 206 (FIG. 5) provided that the external end of the body 170. The closure member 190 further includes a dust cap end 208 so that when the closure member is secured to the body 170, the internal cavity 180 of the body is protected from the external environment. Similarly, a dust cap 210 (FIG. 7) protects the recess 176 of the body from the external environment. Particularly, the dust cap 210 is received over the central portion 122 of the holder 104. A tether 212 may also be provided to secure the closure member 190 to the body 170.

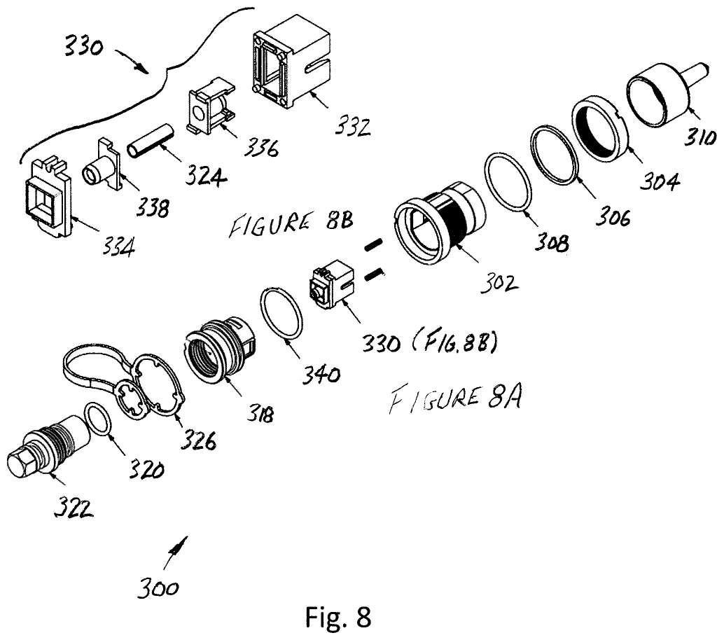

Shown in FIG. 8A is a prior art bulkhead adapter assembly 300. The bulkhead adapter 300 likewise includes a number of individual components that are assembled together specifically a body 302, threaded member/nut 304, ring 306, first seal member 308, cover/dust cap 310, closure member/flange 318, second seal member 320, closure member 322, sleeve 324, and tether 326. An important distinction relative to the new bulkhead adapter assembly 100 of the present disclosure is that the modified body 170 of the present arrangement includes integrally molded components therein that replace the multiple components of a shroud subassembly 330 (FIG. 8B) that included first and second shroud portions 332, 334, and first and second holder portions 336, 338, as well as a third seal member 340. Although the present arrangement includes a holder 104, the second holder portion 338, two-part shroud portions 332, 334, and third seal member 340 are eliminated. This reduces potential leak paths, and provides a much simpler assembly. Further, inventory is reduced, and tolerance stack-up issues are minimized as a result of assembling a fewer number of components while still providing for an effective connection between optic fibers received in the sleeve 130 and holder 104.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

I claim:

1. A bulkhead adapter assembly configured at a first end to receive an associated optical fiber connector housing a terminal end of an associated fiber, and is joined to an associated closure at a second end, the bulkhead adapter assembly comprising:
an elongated holder having at least first and second flexible arms extending axially outwardly from a first end of the holder along a first axis, the first end of the holder including an opening dimensioned to receive the associated optical fiber therein, a shoulder formed at a terminal end of each of the flexible ends wherein each shoulder has an undercut extending perpendicularly to the first axis that is configured to operatively engage the associated optical fiber connector, a central portion of the holder including a recess extending inwardly from a second end of the holder, and an opening through the central portion that receives the associated optical fiber therethrough;
a sleeve dimensioned for axial receipt in the holder recess dimensioned to receive the associated optical fiber therein, the sleeve aligning the associated optical fiber within the bulkhead adapter assembly;
a hollow body having a recess that receives the holder and sleeve in a first end of the body, the body including an externally threaded first region and an internally threaded second region;
a nut including an internally threaded region that engages the externally threaded first region of the hollow body and having an internal shoulder; and
a base member having an externally threaded region that threadedly interconnects with the internally threaded second region of the body.

2. The adapter assembly of claim 1 wherein the sleeve is a ceramic material.

3. The adapter assembly of claim 1 further comprising a first seal member interposed between the nut and body, and a second seal member interposed between the body and base member to seal around the associated optical fiber connector.

4. The adapter assembly of claim 3 wherein each of the flexible arms includes a tapered surface adjacent a terminal end thereof configured to abuttingly engage the associated optical fiber connector such that the arms diverge away from each other as the associated optical fiber connector is advanced relative to the flexible arms.

5. The adapter assembly of claim 1 wherein each of the flexible arms includes a tapered surface adjacent a terminal end thereof configured to abuttingly engage the associated optical fiber connector such that the arms diverge away from each other as the associated optical fiber connector is advanced relative to the flexible arms.

6. The adapter assembly of claim 5 wherein the central portion of the holder is located axially inward from terminal ends of the first and second flexible arms such that the flexible arms extend over a greater axial extent of the associated optical fiber connector when received in the holder recess.

7. The adapter assembly of claim 1 wherein the nut includes one or more indentations/notches configured to receive a mating, specially configured associated tool to rotate the nut onto the body and retain the holder and sleeve in the body.

8. A method of assembling a bulkhead adapter assembly configured at a first end to receive an associated optical fiber connector housing a terminal end of an associated fiber, and joined to an associated closure at a second end, the method comprising:
providing an elongated holder having at least first and second flexible arms extending axially outwardly from a first end of the holder along a first axis, the first end of the holder including an opening dimensioned to receive the associated optical fiber therein, a shoulder formed at a terminal end of each of the flexible ends wherein each shoulder has an undercut extending perpendicularly to the first axis that is configured to operatively engage the associated optical fiber connector, a central portion of the holder including a recess extending inwardly from a second end of the holder, and an opening through the central portion that receives the associated optical fiber therethrough;
receiving a sleeve in the holder recess dimensioned wherein the sleeve is dimensioned to receive the associated optical fiber therein;
using the sleeve to align the associated optical fiber within the bulkhead adapter assembly;
providing a hollow body having a recess and receiving the holder and sleeve in a first end of the body, the body including an externally threaded first region and an internally threaded second region;
threadedly engaging a nut having an internally threaded region with the externally threaded first region of the hollow body; and
threadedly engaging a base member having an externally threaded region with the internally threaded second region of the body.

9. The method of claim 8 including forming the sleeve of a ceramic material.

10. The method of claim 8 further comprising interposing a first seal member between the nut and body, and interposing a second seal interposed between the body and base member to seal around the associated optical fiber connector.

11. The method of claim 10 further comprising providing a tapered surface adjacent a terminal end of each flexible arm to abuttingly engage the associated optical fiber connector such that the arms diverge away from each other as the associated optical fiber connector is advanced relative to the flexible arms.

12. The method of claim 8 further comprising providing a tapered surface adjacent a terminal end of each flexible arm to abuttingly engage the associated optical fiber connector such that the arms diverge away from each other as the associated optical fiber connector is advanced relative to the flexible arms.

13. The method of claim 12 further comprising locating the central portion of the holder axially inward from terminal ends of the first and second flexible arms such that the flexible arms extend over a greater axial extent of the associated optical fiber connector when received in the holder recess.

14. The method of claim 8 further comprising providing one or more indentations/notches in the nut configured to receive a mating, specially configured associated tool to rotate the nut onto the body and retain the holder and sleeve in the body.
